(19) United States
(12) Patent Application Publication
(10) Pub. No.: US 2023/0286200 A1
(43) Pub. Date: Sep. 14, 2023

(54) SUPPORT BEARING ELEMENT FOR AN EXTRUDER SCREW FOR A MULTI-SCREW EXTRUDER

(71) Applicant: Gneuss GmbH, Bad Oeynhausen (DE)

(72) Inventors: Daniel GNEUSS, Charlotte, NC (US); Detlef GNEUSS, Carabietta (CH); Stephan GNEUSS, Bad Oeynhausen (DE)

(73) Assignee: Gneuss GmbH, Bad Oeynhausen (DE)

(21) Appl. No.: 18/198,090

(22) Filed: May 16, 2023

Related U.S. Application Data
(63) Continuation of application No. PCT/DE2021/100911, filed on Nov. 16, 2021.

(30) Foreign Application Priority Data
Nov. 17, 2020 (DE) 10 2020 130 368.8
Sep. 16, 2021 (DE) 10 2021 124 034.4

(51) Int. Cl. B29C 48/25; B29C 48/44

(52) U.S. Cl. CPC B29C 48/2522; B29C 48/44

(57) ABSTRACT

A support bearing element for an extruder screw for a multi-screw extruder, at least comprising a cone, a plurality of grooves, which are located on the outer periphery and are axially parallel to the axis of rotation of the support bearing element, each for receiving a satellite screw and a drive pinion connected thereto. At least one plain bearing is provided in the groove in order to support the satellite screw next to the drive pinion thereof, the plain bearing being positioned or designed in a bearing holder formed on the support bearing element.

This nonprovisional application is a continuation of International Application No PCT/DE2021/100911, which was filed on Nov. 16, 2021, and which claims priority to German Patent Application No 10 2020 130 368.8, which was filed in Germany on Nov. 17, 2020, and German Patent Application No 10 2021 124 034.4, which was filed in Germany on Sep. 16, 2021 and which are all herein incorporated by reference.

### BACKGROUND OF THE INVENTION

### Field of the Invention

The invention relates to a support bearing element for an extruder screw for a multi-screw extruder.

### Description of the Background Art

For the processing of molten plastics, especially polyester, a multi-rotation system (MRS) has proven to be successful, which is fundamentally described in WO 2003 033 240 A1, which corresponds to U.S. Pat. No. 7,513,677, which is incorporated herein by reference. It contains an extruder screw that includes a so-called polyrotation unit with a rotor body shaft between an input zone for drawing in and melting the plastic and a discharge zone. The latter has a rotor body with a significantly larger diameter as compared to the other zones and also several rotating satellite screws mounted in it. With the multi-rotation system, a significant increase in degassing performance is achieved as compared to single and twin screw systems. Consequently, the residence time of the melt in the polyrotation unit can be kept very short.

The well-known drive concept provides a drive zone for the satellite screws, which is located within the processing chamber intended for degassing. The arrangement of the drive zone directly at the upstream end of the multi-rotation system is necessary in most applications and cannot be shifted to the downstream end so that the length of the section of the extruder screw that is loaded by the drive torque is kept short.

The melt transferred from the metering zone via the cone is passed through the drive zone of the satellite screws. In some applications, the energy input via the shear that occurs there can be advantageous because it favors the homogenization of the plastic melt. On the other hand, the shear of the polymer in the drive zone can be detrimental to the product properties. The shear causes an increase in temperature, which may be compensated for by cooling measures and the already heavily loaded materials in the drive zone.

The drive zone of the satellite screws is highly loaded in various respects. The toothing, formed of the drive pinions in each case attached to the satellite screws and a toothed ring with internal toothing on the housing side, can only be lubricated by the hot polymer. Therefore, it is necessary for the polymer to flow through the drive zone. As a result, however, even in the metering zone, hard plastic particles that have not completely melted enter the drive zone. When plastics are recycled, impurities such as metal particles or grains of sand can also be contained in the plastic melt. In addition, the melt pressure of the melt flowing on the outer periphery of the extruder screw causes the drive pinions of the floating satellite screws to be pressed into the mounting grooves on the support bearing element and the tooth flanks there cause severe wear and are also subject to heavy wear themselves.

### SUMMARY OF THE INVENTION

It is therefore an object of the invention to improve an extruder screw for an MRS system or a multi-screw extruder equipped with it in such a way that the wear in the drive zone of the satellite screws is reduced.

The solution according to the present invention includes a support bearing element for an extruder screw, which may be part of an extruder screw, which in turn may be part of a multi-screw extruder.

According to the invention, it is provided to support the satellite screws in their grooves in the support bearing element in a defined manner at least on one side next to the drive pinion by means of a plain bearing in order to counteract the melt pressure and to prevent the drive pinion from scraping over the bottom of the groove with the outer flanks of its toothing. Thus, the invention departs from the previously known concept of a drive section of the satellite screw floating purely in the polymer.

For the purposes of the invention, it may be provided to form the end of the satellite screw as a bearing shoulder mounted in a bearing recess on the support bearing element. In this embodiment, the bearing recess is located directly behind the cone, which is the transition between the metering zone and the degassing zone. In this case, a plain bearing is formed directly by the bearing shoulder on the satellite screw and the associated bearing recess.

In order to be able to compensate for tolerances that occur as a result of the heating or cooling of the extruder screw during operation, it may be provided not to insert the bearing shoulders directly into the respective bearing recess, but to store them in an additional bearing insert element used there, so that the plain bearing is formed between the bearing insert element and the bearing shoulder on the satellite screw or between the bearing insert element and the bearing recess.

The satellite screw can be supported on both sides next to the drive pinion in plain bearings. In addition to the end-side bearing, there is another bearing shoulder between the area of the screw, which has a screw flight, and the area for receiving the drive pinion.

The bearing holes of the end-side bearing as well as the second bearing, if any, on the other axial side of the drive pinion, can each be formed in a separate bearing insert element, which is inserted into the groove on the support bearing element. In the case of the bearing insert element, the outer contour largely corresponds to the inner contour of the mounting groove. Since this is preferably cut deeply, the bearing insert element is positively held in the groove without additional securing elements in the cross-sectional plane aligned transversely to the central axis and can be inserted into the support bearing element together with the satellite screw. A deeply cut groove is present when the cross-section of the groove covers an arc of more than 180°.

Furthermore, the end-side bearing of the satellite screw can also be formed by such a bearing insert element, which is inserted into the groove. This means that both bearing insert elements can be easily replaced in the event of wear. For them, a metallic material can be selected that is recompacted by hot isostatic pressing (HIP) to increase wear resistance. The support bearing element can thus be formed from other suitable materials, regardless of the requirements for the strength of the bearing points.

A significant proportion of the melt flow in the drive zone is not routed over the drive pinions, but past the drive pinions in channels within the support bearing element. The advantage of this is that the melt is not heated by shear. For example, when processing PET, it is advantageous if the melt is not completely plasticized and is therefore relatively cool, so that excessive degradation of the melt can be avoided already in the input area. For the extruder screw itself, a further advantage is that the risk of damage to it is reduced in the event of contamination of the melt.

For the effectiveness of the flow channels, it is important that they are selected to be large enough so that a large proportion of the volume flow of polymer conveyed and processed with the extruder screw is not passed through the drive zone. A sufficient cross-section is also important to prevent non-fully plasticized material of the feed screw from clogging the channels and leading to a high pressure drop. Both cause a high head pressure at the end of the feed and thus a significantly higher energy input and thus avoid damage to the melt.

Specifically, the channels should provide at least 5 mm of free cross-section in each dimension, preferably 8 mm to 10 mm.

Preferably, the support bearing element is part of an extruder screw for a multi-screw extruder having the features of claim 6.

The support bearing element designed according to the invention may be part of a one-piece rotor body. However, in order to be able to replace or rework the support bearing element independently of the rest of the rotor body in the event of wear, it is advantageous if the rotor body and the support bearing element are separately manufactured but firmly connected with their cross-sections merging flush into each other. The grooves for holding the satellite screws thus also merge into each other on both parts, so that a plain bearing arranged between the drive pinion and the beginning of the screw flight can be arranged both in the groove on the support bearing element and in the groove continued in the rotor body.

The extruder screw may be part of a multi-screw extruder having the features of claim 10.

It is particularly advantageous if flow channels are routed around the toothing on the outside, i.e., are inserted into the wall of the extruder housing and/or into the stator ring.

The annular gap between the outside of the support bearing element and the inside of the extruder bore in the housing should have a radial width of preferably 1 mm to 3 mm and a maximum of 5 mm. For example, with a diameter of 130 mm, the annular gap is designed to be 1.6 mm to 2.0 mm.

This specifies that only a small volume flow flows over the outer periphery so that the polymer can act as a lubricant in the drive zone, while the larger proportion of the volume flow is divided among the flow channels and thus does not experience any shear in the drive zone. It is also advantageous if the size of the annular gap is chosen so small, since foreign bodies are retained in the melt flow that are of such a size that they can lead to significant mechanical damage to the gearing.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a support bearing element with further parts of an extruder screw in perspective view;

FIG. 2 is a perspective view of the support bearing element according to an example;

FIGS. 3A and 3B are case parts of the extruder screw with the support bearing element according to FIG. 2 in perspective view; and

FIG. 4 shows parts of a multi-screw extruder with the extruder screw in lateral section view;

FIG. 5 is a perspective view of a support bearing element according to an example;

FIG. 6 is a perspective view of the back of the support bearing element as shown in FIG. 5;

FIG. 7 is a perspective view of an arrangement of several satellite screws of the extruder screw; and

FIG. 8 is a perspective view of a support bearing element according to an example.

### DETAILED DESCRIPTION

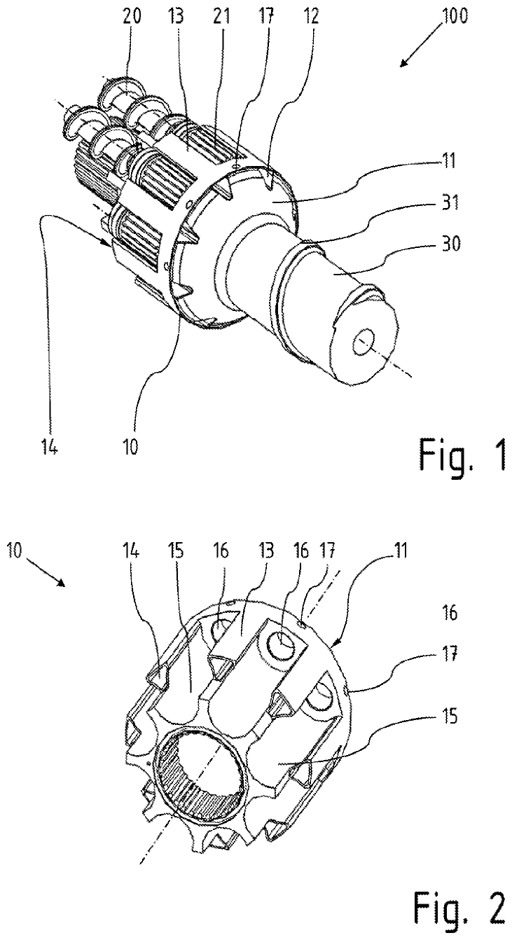

FIG. 1 shows a support bearing element 10 with further parts of an extruder screw 100 for a multi-screw extruder in perspective view, namely the transition area between an intake and metering section 30 with a screw flight 31 and a multi-screw section with several satellite screws 20. In between, a cone 11 is formed so that the diameter of the extruder screw 100 expands in the direction of flow. The cone 11 is part of a support bearing element 10. In grooves inserted therein, the satellite screws 20 are each supported with their end section, which is provided with a drive pinion 21.

Between adjacent drive pinions 21, an elongated, axial section of the support bearing element 10 is provided, in which a tubular flow channel 13 is formed. The flow channel 13 extends from an inlet opening 12 on the cone 11 to an outlet opening 14, which ends in axial extension of the extruder screw 100 and in the direction of flow beyond the drive pinion 21.

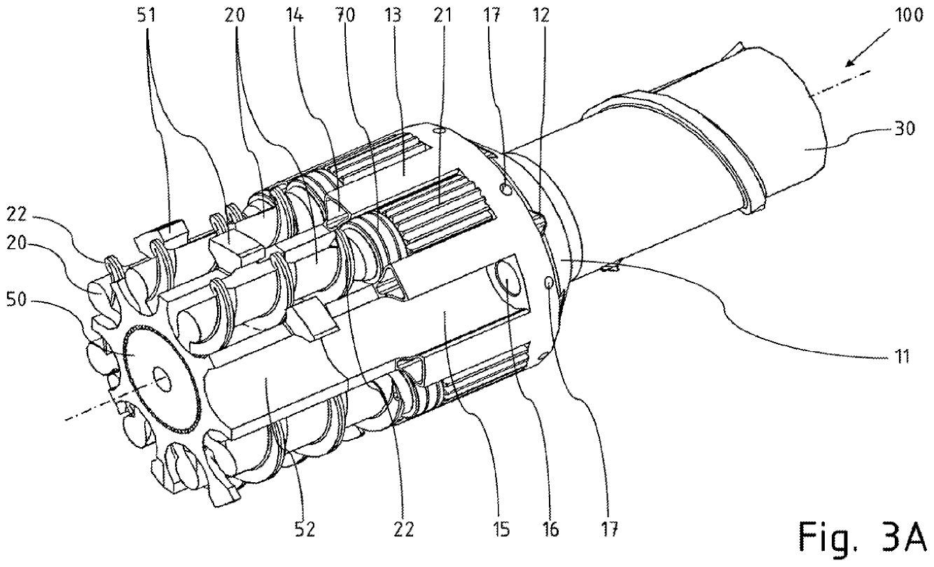

FIG. 2 is a perspective view of the support bearing element 10. This has a groove 15 for each satellite screw, in which the drive pinion is mounted, and a bearing recess 16 in front of the head, into which a bearing shoulder of the satellite screw or the drive pinion can be inserted, so that a plain bearing is formed. The plain bearings of the satellite screws, such as the drive pinions, are lubricated by the polymer conveyed with the extruder screw. Since the bearing recesses 16 are shielded from the flow by the cone 11, radial bores 17 are provided for the lubrication of the plain bearings, each of which extends from the outer circumference to the bearing recess 16.

FIG. 2 also clearly shows a trapezoidal, almost triangular cross-section of the flow channels 13. The fact that the tip of the triangular cross-sectional surface points to the central axis and the wide base is on the outer periphery makes optimum use of the space between the drive pinions. In each case, the outlet openings 14 of the flow channels 13 are not located at the end of the support bearing element 10; rather, the flow channels 13 extend axially only about as far as the drive pinions reach.

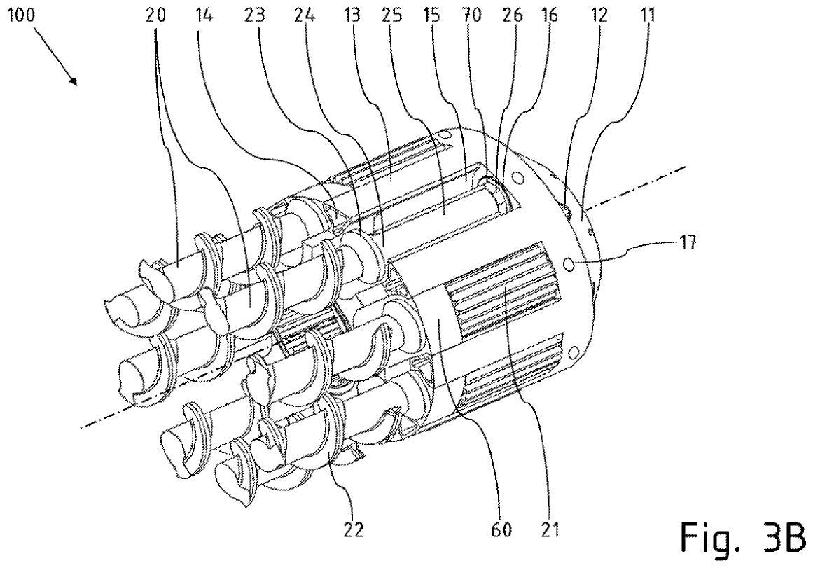

The advantage of this arrangement is shown in FIG. 3A. There, the extruder screw 100 with its intake and metering section 30, the support bearing element 10 and the satellite screws 20 is shown in perspective. In addition, a part of a rotor body 50 is shown, which adjoins the support bearing element 10.

The grooves 15 of the support bearing element 10 continue in grooves 52 on the rotor body 50. The satellite screws 20 are guided in grooves 15, 52, wherein they are exposed with the outside. The rotor body 50 has portions of its own main screw flight 51 between the grooves 52. As a result of the fact that the outlet openings 14 of the flow channels 13 do not extend to the end of the support bearing element 10, the melt gushing out of the outlet opening 14 reaches directly laterally into the intake area of the main screw flight 51 and the flights 22 on the satellite screws 20.

A plain bearing element 70 is mounted on a rear bearing shoulder terminating in front of the area of the screw flight 22, which has a helical non-return valve on the outer periphery in order to convey melt in the direction of the treatment chamber, and thus away from the drive pinion 21.

FIG. 3B is similar to FIG. 3A. Compared to the illustration in FIG. 3A, however, the rotor body is not shown. In addition, one of the drive pinions 20 of a satellite screw 20 is removed to allow for a view of the formation of the satellite screws 20 in their end area.

The long part of the satellite screws 20 intended for polymer processing, which is provided with the screw flight 22, ends at a flange 23, the diameter of which is so large that the adjacent bearing shoulder is largely covered. This prevents excessive backflow from the degassing chamber of the extruder into the area of the drive pinion 21 during operation.

The plain bearing elements of the satellite screws 20 are each received in a bearing insert element 60, which is inserted into the groove 15 of the support bearing element 10. Behind the shoulder 24 for the plain bearing element, a bearing section 25 is formed on each of the satellite screws 20, which receives the drive pinion 21.

At the very end of the satellite screw 20, another bearing shoulder 26 is formed, which either engages directly with the bearing recess 16 in the support element 10 and forms a plain bearing with the bearing recess or which engages in a separate plain bearing element located there.

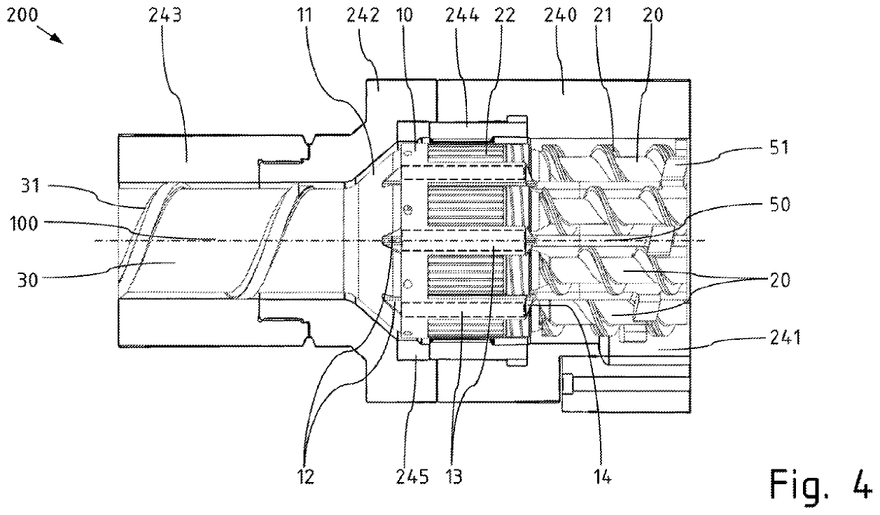

FIG. 4 shows parts of a multi-screw extruder 200 in lateral sectional view. The same section of the extruder screw shaft 100 is shown as in FIG. 3A. The extruder screw shaft 100 is rotatably mounted in an extruder housing 240 with an extruder bore 241.

The extruder housing 240 has a transition housing part 242 to receive the cone 11 and a housing part 243 with a reduced diameter to receive the intake and metering section 30 of the extruder screw 100. In the drive zone, a stator ring 244 is inserted into the extruder bore 241, which has an internal toothing into which the drive pinions 21 of the satellite screws 20 engage. In addition, a retaining ring 245 is used to adjust the annular gap between an inner wall of the extruder housing 240 and the outer periphery of the extruder screw 100 at this point.

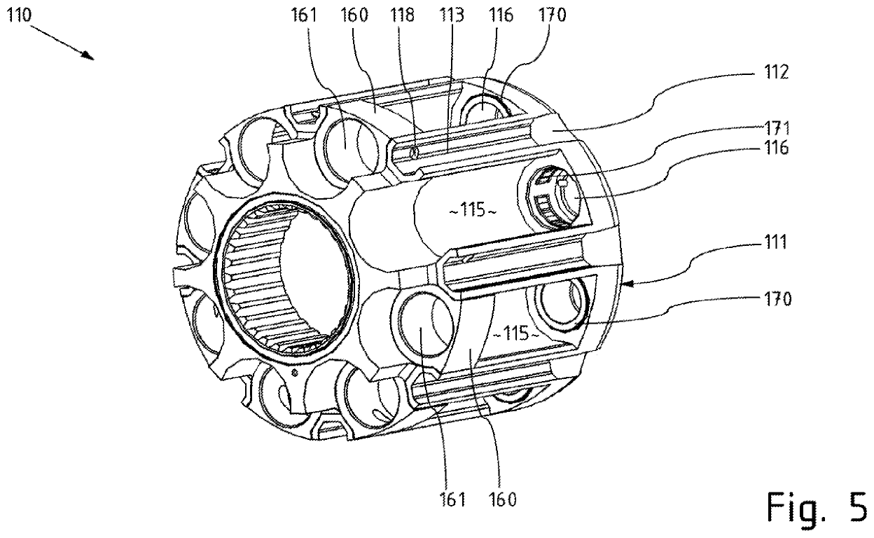

FIG. 5 shows a further example of a support bearing element 110 with grooves 115 for accommodating the satellite screws with their drive pinions. On a rear section, which is designed as a cone 111, bearing recesses 116 are formed, in which one plain bearing element 170 with a clamping ring 171 is inserted for each satellite screw, which serves to hold the plain bearing element 170 in the support bearing element 110. Due to differences in thermal expansion, the fit between the support bearing element 110 and the plain bearing element 170 may change. The clamping ring 171 prevents the plain bearing element 170 from rotating in the support bearing element 110.

For each second bearing point, a bearing insert element 160 with a bearing recess 161 is inserted into the groove 115. What differs from the first embodiment of the support bearing element 10 according to FIGS. 3A, 3B and 4 is that in the support bearing element 110 flow channels 113 are formed, which are open at the outer periphery. A channel 118 branches off from each of them, which ends in the bearing recess 161 of the bearing insert element 160 in order to ensure lubrication there.

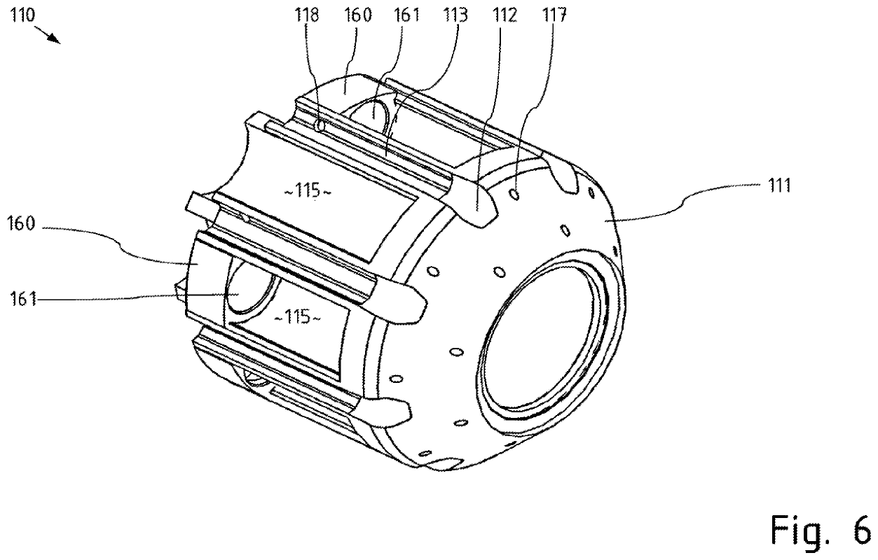

FIG. 6 is a perspective view of the rear of the support bearing element 110. Of particular note are the holes 117, each of which is located between two inlet openings 112 of the flow channels 113 and ends laterally in the bearing recesses 116 (see FIG. 5) in order to lubricate the plain bearings arranged there with polymer that is diverted from the production flow.

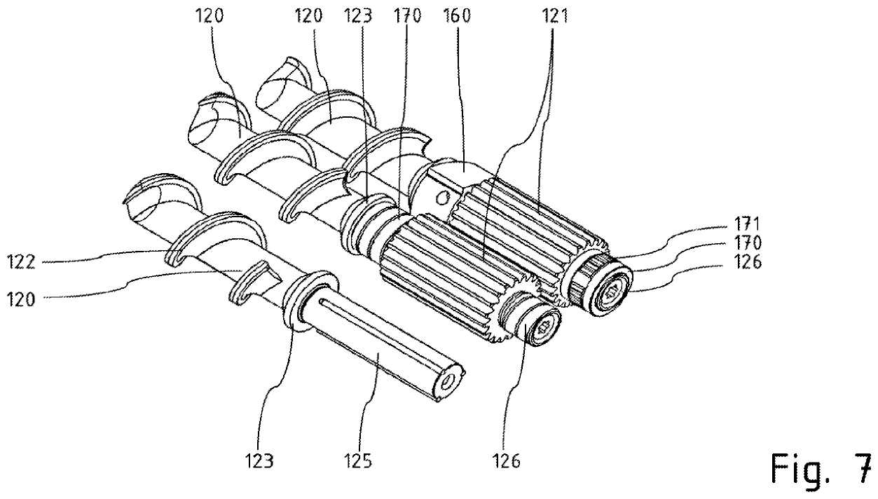

FIG. 7 shows three of the satellite screws 120, which are intended to be received in the support bearing element 110 shown in FIGS. 5 and 6.

On the left is a satellite screw 120 with a screw flight 122 without additional parts. The screw flight 122 ends at a flange 123. Behind it is a bearing section 125.

In the case of the center satellite screw 120, a drive pinion 121 is mounted on the bearing section 125. This includes not only a toothed area, but also a plain bearing element 124, 126 on each side of it with external spiral grooves that form a return thread.

In the case of the satellite screw 120 shown on the far right in FIG. 7, the following are mounted: the drive pinion 121; a bearing insert element 160 disposed in front of the drive pinion 21 in the direction of conveyance of the extruder screw and in which a plain bearing element 170 is inserted; a plain bearing element 170 into which the end-side bearing shoulder 126 of the satellite screw 120 is inserted; and a clamping ring 171 surrounding the plain bearing element 170.

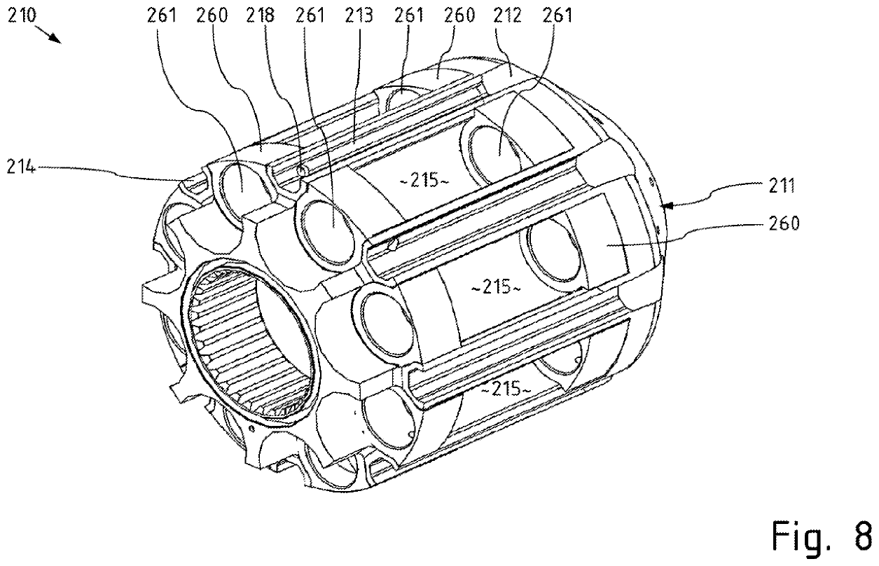

FIG. 8 shows an example of a support bearing element 210, which in turn has a cone 211 at its one end and has a large number of undercut grooves 215 on the periphery, in which the drive zone of the satellite screws with their drive pinions is formed when the support bearing element is fitted as part of an extruder screw shaft. In the case of the support bearing element 210, the bearing holders 261 are provided for the two bearing points of the satellite screws on both sides of the respective drive pinion in separate bearing insert elements 260.

Flow channels 213 extend from inlet openings 212 at the cone 211 to outlet openings 214. Channels 218 branch off from the flow channel 213 and extend into bearing holders 261 of the bearing insert elements 260. In this embodiment, too, the bearing insert elements 260 are adapted with their outer contour to the inner contour of the grooves 215 in such a way that they are positively fixed in a plane transversely to the central axis, i.e., they cannot be moved radially outwards. The axial fixation of the bearing insert elements 260 is carried out by means of shoulders on the satellite screws.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A support bearing element for an extruder screw for a multi-screw extruder, the support bearing element comprising:
a cone;
a plurality of grooves arranged on an outer periphery and are axially parallel to the axis of rotation of the support bearing element, each for receiving a satellite screw and a drive pinion connected thereto; and
at least one plain bearing provided in the groove in order to support the satellite screw next to the drive pinion thereof, the plain bearing being positioned or designed in a bearing holder formed on the support bearing element.

2. The support bearing element according to claim 1, wherein at least one plain bearing is positioned in a bearing insert element that is detachably inserted into the groove.

3. The support bearing element according to claim 2, wherein the groove is undercut and that the bearing insert element is positively retained in the groove in a plane transversely to the central axis of the extruder screw.

4. The support bearing element according to claim 1, wherein at least one bore is inserted on the outer periphery of the support bearing element for each plain bearing, which extends into the respective groove for the drive pinion of the satellite screw or into the bearing holder.

5. The support bearing element according to claim 1, wherein, between at least two adjacent grooves, a flow channel is formed in the support bearing element, which extends from an inlet opening on the cone to an outlet opening arranged in the direction of flow behind the position provided for the drive pinions.

6. An extruder screw for a multi-screw extruder, the extruder screw comprising:
an intake and metering section;
a rotor body enlarged in diameter as compared to the intake and metering section;
a plurality of satellite screws, which have at least one screw flight and are located on the outer periphery of the rotor body exposed at least part over part of their length;
a drive zone on the rotor body in which the satellite screws each have a drive pinion in order to engage in an internal toothing in or on the inner wall of an extruder housing of the multi-screw extruder;
a cone formed between the intake and metering section and the drive zone on the rotor body;
wherein the rotor body is connected to the support bearing element according to claim 1, on which the cone is formed and that the satellite screws are each mounted in at least one plain bearing in the support bearing element arranged next to the drive pinion.

7. The extruder screw according to claim 6, wherein the satellite screws each have an end-side bearing shoulder which is mounted in a plain bearing in a bearing holder in the support bearing element or in the rotor body in a bearing insert element inserted therein.

8. The extruder screw according to claim 7, wherein the plain bearing for the end-side bearing shoulder of the satellite screws is each arranged in a bearing holder in the support bearing element, which is arranged next to the cone.

9. The extruder screw according to claim 7, wherein the satellite screws are each mounted in at least one plain bearing which is positioned at an axial position between the drive pinion and the beginning of the screw flight.

10. The multi-screw extruder comprising:
an extruder housing with an extruder bore; and
an extruder screw according to claim 6, which is rotatably mounted in the extruder bore and whose drive pinion engages in an external toothing on the rotor body section of the extruder screw or in an internal toothing in a stator ring or in the inner wall of the housing.

11. The multi-screw extruder according to claim 10, further comprising a drive zone in which the drive pinions are arranged in the grooves, wherein, in the support bearing element, at least one flow channel is formed between two adjacent grooves or in a housing wall of the extruder housing, at least one flow channel is formed which, seen in the longitudinal direction, extends from an inlet opening located in front of the position of the drive pinions to an outlet opening located beyond the drive pinions.

12. The multi-screw extruder according to claim 11, wherein the flow channels are completely closed and tubular in shape.

13. The multi-screw extruder according to claim 11, wherein the flow channels are designed to be open on the outer periphery.

14. The multi-screw extruder according to claim 11, wherein the flow channels are formed in a stator ring and/or in a retaining ring inserted into the extruder bore in the drive zone.
